(19) United States
(12) Patent Application Publication
(10) Pub. No.: US 2017/0048769 A1
(43) Pub. Date: Feb. 16, 2017

(54) CELL SWAPPING FOR RADIO RESOURCE MANAGEMENT (RRM) FURTHER ENHANCED NON CA-BASED ICIC FOR LTE METHOD AND APPARATUS

(71) Applicant: ZTE CORPORATION, Guangdong, Shenzhen (CN)

(72) Inventor: Carolyn TAYLOR, Homewood, IL (US)

(73) Assignee: ZTE CORPORATION (CHINA), Nanshan District, Guangdong Shenzhen (CN)

(21) Appl. No.: 15/114,446

(22) PCT Filed: Jan. 29, 2015
(86) PCT No.: PCT/IB2015/000831

§ 371 Date: Jul. 27, 2016

Related U.S. Application Data
(60) Provisional application No. 61/934,150, filed on Jan. 31, 2014.

(51) Int. Cl. H04W 36/08; H04B 17/318; H04W 36/24

(52) U.S. Cl. CPC H04W 36/08; H04W 36/24; H04B 17/318

(57) ABSTRACT

A wireless communication system includes a plurality of communication devices. The RF transceiver includes a transmitter and a plurality of receivers, each receiving signal from an associated communication device. An Enhanced Node B (eNB) can communicate with a plurality of communication devices in a Multiple-Input Multiple-Output (MIMO) system. The eNB includes a transmitter and plurality of antenna configured to transmit control information. The Reference Signal Received Power (RSRP) is the linear average over the power contributions (in[W]) of the resource elements that carry cell-specific reference signals within the considered measurement frequency bandwidth. The invention deals with swapping between cells in Radio Resource Management (RRM) Further Enhanced Non CA-based Inter-cell Interference Coordination (ICIC) for LTE measurement RSRP accuracy test cases.

### FIELD OF THE INVENTION

The present invention relates to a method for swapping between cells in Radio Resource Management (RRM) Further Enhanced Non CA-based ICIC for LTE measurement RSRP accuracy test cases. The Serving cell (PCell) and the Neighbor Aggressor cell are switched for absolute accuracy of RSRP intra-frequency measurement testing. The Serving cell (PCell) and the Neighbor Aggressor cell are switched for relative RSRP accuracy of RSRP intra-frequency measurement testing. Specifically, the invention relates to a method for swapping between cells in Radio Resource Further Enhanced Non CA-based ICIC for LIE measurement RSRP accuracy test cases.

### BACKGROUND OF THE INVENTION

Devices with wireless communications capabilities, such as mobile telephones, handheld devices, devices embedded in laptop computers, Machine-2-Machine devices (M2M), and similar devices, will be referred to herein as User Equipment (UE).

Wireless communications are continuously evolving. There are many advanced technology equipment being introduced that can provide services that were not possible previously. This advanced technology equipment might include, for example, an Enhanced Node B (eNB) rather than a base station or other systems and devices that are more highly evolved than the equivalent equipment in a traditional wireless telecommunications system. Such advanced or next generation equipment may be referred to herein as High Speed Packet Access (HSPA) equipment, long-term evolution (LTE) equipment and long-term evolution (LTE) Advanced equipment.

In traditional wireless telecommunications systems, transmission equipment in a base station transmits signals throughout a geographic region and is called a “cell”. For LTE and other advanced equipment, the region in which a UE can gain access to a wireless communications network might be referred to as a different name, for instance called a “hot spot”. The terminology for example “cell” will be used herein to refer to any geographic region in which a UE can gain access to a wireless communications network, regardless of the type of UE and regardless of whether the region is a traditional cell, a region served by LTE equipment such as an eNB, or some other region in which wireless communications services are available.

A Heterogeneous network (HetNet) is a network consisting of infrastructure points with various wireless access technologies, each of them having different capabilities, constraints, and operating functionalities. HetNets consist of a mix of macrocells, remote radio heads, and low-power nodes such as picocells, femtocells, and relays.

Leveraging network topology, increasing the proximity between the access network and the end-users, has the potential to provide the next significant performance leap in wireless networks, improving spatial spectrum reuse and enhancing indoor coverage.

Different UEs might use different types of radio access technology (RAT) to access a wireless communications network. Some UEs, which can be referred to as multi-mode UEs are capable of communicating using more than one RAT. For example, multi-mode UEs may include UEs that can obtain service from at least one mode of UMTS (Universal Mobile Telecommunications System), and one or more different systems such as GSM (Global System for Mobile Communications) bands or other radio systems. As defined herein, multi-mode UEs may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is included herein by reference for all purposes. Some examples of RATs or of network technologies that might use different types of RATs include UTRAN (UTMS Terrestrial Radio Access Network), GSM, GSM EDGE Radio Access Network (GERAN), Wireless Fidelity (WiFi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

Inter-cell interference coordination (ICIC) has the task to manage radio resources such that inter-cell interference is kept under control. ICIC mechanism includes a frequency domain component and time domain component. ICIC is inherently a multi-cell Radio Resource Management (RRM) function that needs to take into account information (e.g. the resource usage status and traffic load situation) from multiple cells. The preferred ICIC method may be different in the uplink and downlink.

The frequency domain ICIC manages radio resource, notably the radio resource blocks, such that multiple cells coordinate use of frequency domain resources.

For the time domain ICIC, subframe utilization across different cells are coordinated in time through backhaul signalling or OAM configuration of so called Almost Blank Subframe patterns. The Almost Blank Subframes (ABSs) in an aggressor cell are used to protect resources in subframes in the victim cell receiving strong inter-cell interference. Almost blank subframes are subframes with reduced transmit power (including no transmission) on some physical channels and/or reduced activity.

Reference signal received power (RSRP), is the linear average over the power contributions (in [W]) of the resource elements that carry cell-specific reference signals within the considered measurement frequency bandwidth.

For RSRP determination the cell-specific reference signals R0 shall be used. If the UE can reliably detect that R1 is available it may use R1 in addition to R0 to determine RSRP.

The reference point for the RSRP shall be the antenna connector of the UE.

If receiver diversity is in use by the UE, the reported value shall not be lower than the corresponding RSRP of any of the individual diversity branches.

In the tests there are three synchronous cells, Cell 1, Cell 2 and Cell 3, on the same RF channel.

In all test cases, Cell 1 is the Serving cell (PCell) and also the Aggressor cell to Cell 3. Cell 2 is the Neighbor Aggressor cell to Cell 3. Cell 3 is the cell to be measured for RSRP absolute accuracy, whilst both Cell 1 and Cell 3 are measured for RSRP relative accuracy.

The RRM RSRP accuracy test cases should swap cells.

The cell frequency switched should be the frequencies bandwidth as specified.

The frequencies of the cells shall be switched and tested for each configuration.

### BRIEF SUMMARY OF THE INVENTION

An object of the invention is to provide a method for swapping between cells in Radio Resource Management (RRM) Further Enhanced Non CA-based ICIC for LTE measurement RSRP accuracy test cases.

In one aspect of the invention is provided a wireless communication method for a wireless communication system employing ICIC. The ICIC is a non-CA-based for LTE measurement RSRP accuracy. The wireless communication method comprises switching a serving cell, having a first frequency, and a neighbor aggressor cell, having a second frequency, for RSRP accuracy of RSRP intra-frequency measurement testing.

In another aspect of the invention is provided a wireless communication method for a wireless communication system that includes an eNB and a multi-mode UE. The wireless communication method comprises sending, by a transmitter, a periodic measurement, measuring signal strength, and receiving, by a receiver, a report about measurements of signals received by the multi-mode UE from a serving cell and a neighbor cell. Measuring signal strength includes creating a criterion that triggers the multi-mode UE to send a measurement report. The report about measurements of signals received by the receiver includes parameters for swapping cells.

Yet another aspect of the invention provides a wireless communication system that includes a plurality of communication devices. The wireless communication system comprises an RF transceiver and an eNB configured to communicate with the plurality of communication devices in a MIMO system. The RF transceiver includes a transmitter and a plurality of receivers. The eNB includes a transmitter and a plurality of antenna configured to transmit control information. The cells are configured to be swapped in RRM Further Enhanced Non-CA-based ICIC for LTE measurement RSRP accuracy test cases.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a wireless communications system according to an embodiment of the disclosure.

FIG. 2 is a diagram of a data transmission according to an embodiment of the disclosure.

FIG. 3 is a diagram of a method for measuring signal strength according to an embodiment of the disclosure.

FIG. 4 is a diagram of a wireless communications system including a user equipment and serving cell operable for some of the various embodiments of the disclosure.

FIG. 5 is a diagram of a wireless communications system that illustrates the configuration swapping Serving cell (PCell) and Neighbor cell.

### DETAILED DESCRIPTION OF THE INVENTION

The present inventions now will be described more fully hereinafter with reference to the accompanying drawings, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical adaptive data transmission system and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art. Indeed, these disclosure inventions may be embodied in many different forms and should not be construed as limited to the embodiments set forth therein; rather, these embodiments are provided by way of example so that this disclosure will satisfy applicable legal requirements. Like numbers refer to like elements throughout.

In one aspect of the invention is provided a wireless communication method for a wireless communication system employing ICIC. The ICIC is a non-CA-based for LTE measurement RSRP accuracy. The wireless communication method comprises switching a serving cell, having a first frequency, and a neighbor aggressor cell, having a second frequency, for RSRP accuracy of RSRP intra-frequency measurement testing.

In some embodiments, the RSRP accuracy is for absolute accuracy.

In some embodiments, the RSRP accuracy is for relative accuracy.

In some embodiments, the method further comprises switching and testing the first frequency of the serving cell and switching and testing the second frequency of the neighbor aggressor cell.

In some embodiments, the serving cell (PCell) and the neighbor aggressor cell are switched for absolute accuracy of RSRP intra-frequency measurement testing.

In various embodiments, the serving cell (PCell) and the neighbor aggressor cell are switched for relative RSRP accuracy of RSRP intra-frequency measurement testing.

In some embodiments, the frequencies of the serving cell and the neighbor aggressor cell shall be switched and tested for each configuration. In some embodiments, the cell frequency switched should be the bandwidth of the frequencies as specified.

In another aspect of the invention is provided a wireless communication method for a wireless communication system that includes an eNB and a multi-mode UE. The wireless communication method comprises sending, by a transmitter, a periodic measurement, measuring signal strength, and receiving, by a receiver, a report about measurements of signals received by the multi-mode UE from a serving cell and a neighbor cell. Measuring signal strength includes creating a criterion that triggers the multi-mode UE to send a measurement report. The report about measurements of signals received by the receiver includes parameters for swapping cells.

FIG. 1 illustrates a situation in which such a measurement might occur. A UE is moving from a macro technology network toward a micro technology network. The macro technology network includes an eNB, or a similar component. The UE may be engaged in a macro technology running an application via the eNB. That is, the eNB is transmitting data to the UE or is otherwise in communication with the UE.

The method can include a transmitter configured for sending, a periodic measurement.

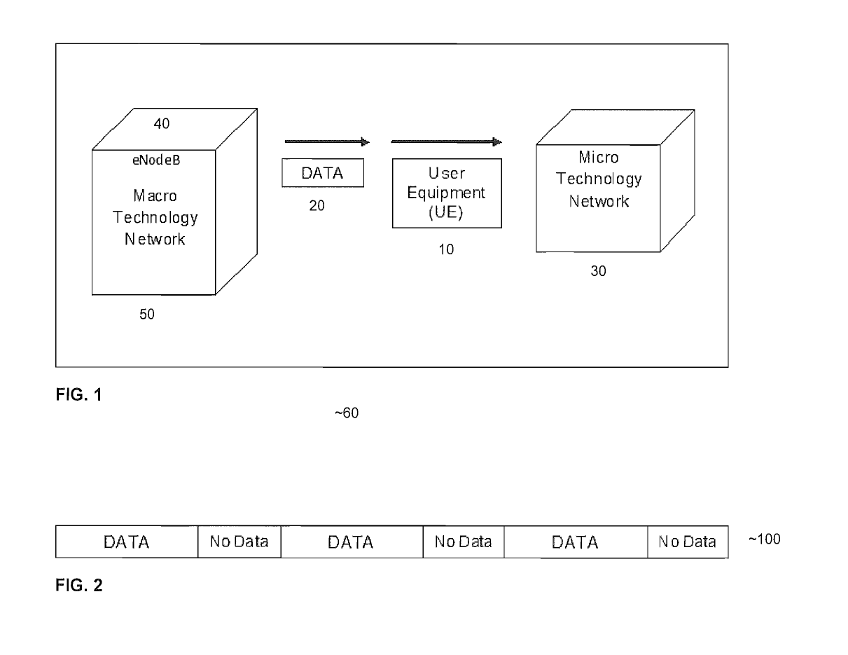

FIG. 2 illustrates a detailed view of the data transmission from the eNB to the UE. The data transmission consists of a series data strings separated by transmission period in which no data and data is transmitted. The data strings might represent some type of a user-directed data transmission. During the period which no data is transmitted, the UE can measure the strengths of the signals that it receives. In a first technique, a method for measuring signal strength is provided. The method includes the multi-mode UE being measured. In an alternative of this technique, a method for measuring signal strength is provided. The method includes periodic measurements to track and monitor traffic load performance.

In some embodiments, the multi-mode UE includes a processor configured to promote measurements of a signal strength in a communication system.

The multi-mode UE may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is included herein by reference for all purposes. Some examples of RATs or of network technologies that might use different types of RATs include UTRAN (UTMS Terrestrial Radio Access Network), GSM, GSM EDGE Radio Access Network (GERAN), Wireless Fidelity (WiFi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

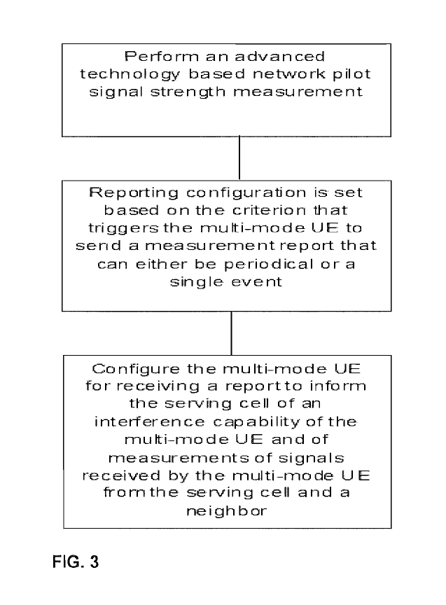

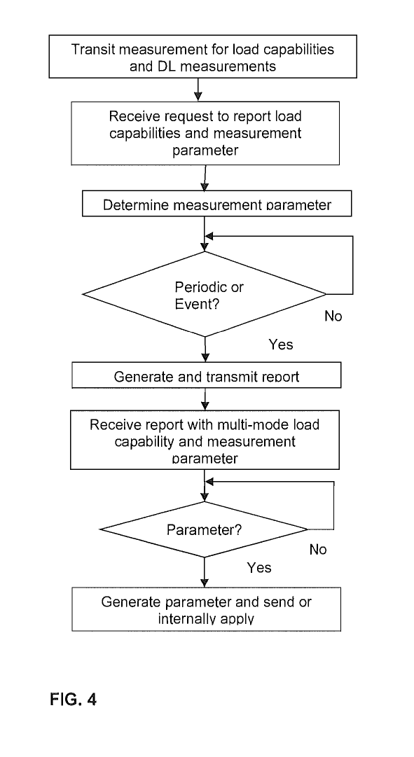

FIG. 3 illustrates an embodiment of a method for measuring the strength of the multi-mode UE of UE according to the loading on the various carriers' capability. The UE send a measurement reporting.

FIG. 4 is a flowchart that illustrates methods of operating a serving cell and a multi-mode UE for a wireless communications system. The serving cell transmits at least one message to at least one multi-mode UE within its cell that the UEs should inform the cell of the capability of the respective UEs and their DL signal measurements, e.g., the RSRP of the serving cell and RSRPs of candidate neighbor cells, which can be macro cells and/or micro/pico/femto cells. The at least one message includes a parameter value for use by a multi-mode UE in determining its parameter according to the loading on the various carriers.

It is appreciated that there are a number of ways of measuring network signal strength. In general, the signal strength is expressed as voltage per length or the actual power of the signal received by a reference antenna. The power of the signal can be calculated if the power delivered to the transmitting antenna as well as the electric field geometry and radiation resistance are known.

In some embodiments, the measuring is periodic. The measuring can also occur when no data is transmitted.

In some embodiments, the multi-mode UE includes a processor configured to promote measurements of a signal strength in a communication system running an application that increasingly demands higher data rates.

In some embodiments, the criterion that triggers the multi-mode UE to send a measurement report is that the signal strength is below a certain threshold. The criterion can either be periodical or a single event description.

In yet another aspect, the invention provides a wireless communication system that includes a plurality of communication devices. The wireless communication system comprises an RF transceiver and an eNB configured to communicate with the plurality of communication devices in a MIMO system. The RF transceiver includes a transmitter and a plurality of receivers. The eNB includes a transmitter and a plurality of antenna configured to transmit control information. Cells are configured to be swapped in RRM Further Enhanced Non-CA-based ICIC for LTE measurement RSRP accuracy test cases.

In some embodiments of the wireless communication system, the RSRP accuracy is for absolute accuracy.

In some embodiments of the wireless communication system, the RSRP accuracy is for relative accuracy.

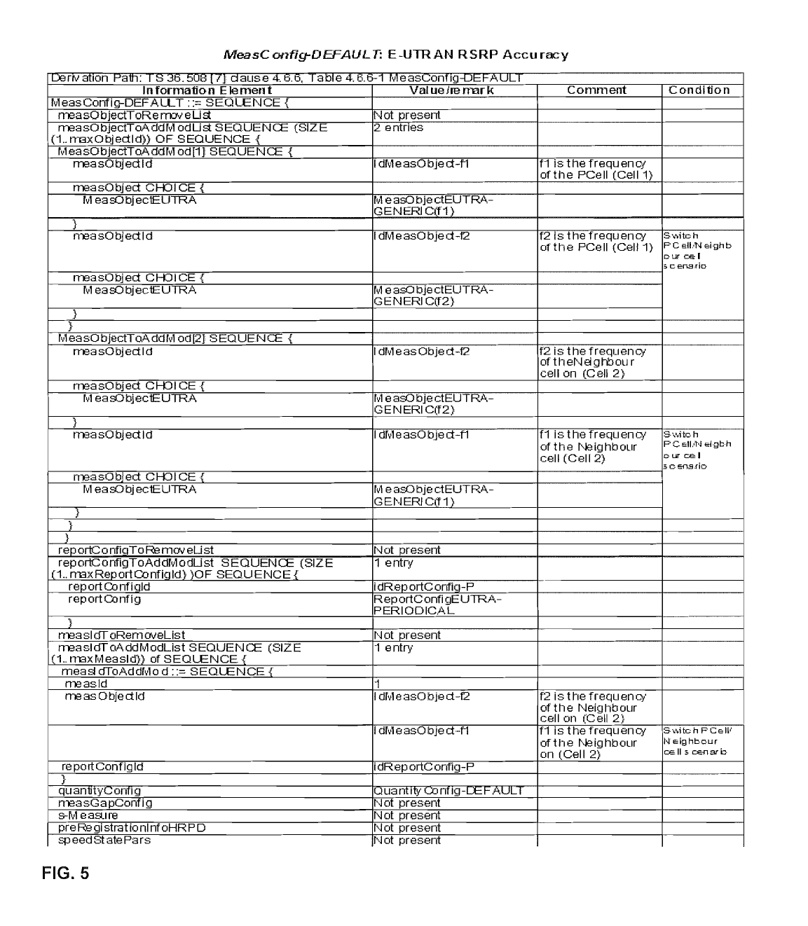

FIG. 5 illustrates an embodiment of a method for swapping between cells in Radio Resource Management (RRM) Further Enhanced Non CA-based ICIC for LTE measurement RSRP accuracy test cases. The Serving cell (PCell) and the Neighbor Aggressor cell are switched for absolute accuracy of RSRP intra-frequency measurement testing. The Serving cell (PCell) and the Neighbor Aggressor cell are switched for relative RSRP accuracy of RSRP intra-frequency measurement testing.

Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes are intended to be included in the invention, the scope of which is defined by the claims.

What is claimed is:

1. A wireless communication method for a wireless communication system employing ICIC, wherein the ICIC is non-CA-based for LTE measurement RSRP accuracy, said wireless communication method comprising:
switching a serving cell, having a first frequency, and a neighbor aggressor cell, having a second frequency, for RSRP accuracy of RSRP intra-frequency measurement testing.

2. The method of claim 1, wherein the RSRP accuracy is for absolute accuracy.

3. The method of claim 1, wherein the RSRP accuracy is for relative accuracy.

4. The method of claim 1, further comprising switching and testing the first frequency of the serving cell and switching and testing the second frequency of the neighbor aggressor cell.

5. A wireless communication method for a wireless communication system that includes an eNB and a multi-mode UE, said wireless communication method comprising:
sending, by a transmitter, a periodic measurement;
measuring signal strength, wherein the measuring includes creating a criterion that triggers the multi-mode UE to send a measurement report; and
receiving, by a receiver, a report about measurements of signals received by the multi-mode UE from a serving cell and a neighbor cell, wherein the report includes parameters for swapping cells.

6. The method of claim 5, wherein the measuring is periodic.

7. A wireless communication system that includes a plurality of communication devices, said wireless communication system comprising:
an RF transceiver, wherein the RF transceiver includes a transmitter and a plurality of receivers; and
an eNB configured to communicate with the plurality of communication devices in a MIMO system, wherein the eNB includes a transmitter and a plurality of antenna configured to transmit control information,
wherein cells are configured to be swapped in RRM Further Enhanced Non-CA-based ICIC for LTE measurement RSRP accuracy test cases.

8. The wireless system of claim 7, wherein the RSRP accuracy is for absolute accuracy.

9. The wireless system of claim 7, wherein the RSRP accuracy is for relative accuracy.
